(19) United States
(12) Patent Application Publication
(10) Pub. No.: US 2014/0237810 A1
(43) Pub. Date: Aug. 28, 2014

(54) DEVICE FOR ATTACHING A KNOB OF A GEAR LEVER FOR A MOTOR VEHICLE

(71) Applicant: DURA AUTOMOTIVE SYSTEMS SAS, Bievres (FR)

(72) Inventors: Hugues Blanc, Lezigneux (FR); Philippe Pradier, Sorbiers (FR)

(73) Assignee: DURA AUTOMOTIVE SYSTEMS SAS, Bievres (FR)

(21) Appl. No.: 14/350,396

(22) PCT Filed: Oct. 3, 2012
(86) PCT No.: PCT/FR2012/052235

§ 371 Date: Apr. 8, 2014

(30) Foreign Application Priority Data
Oct. 13, 2011 (FR) 1159272

(51) Int. Cl. B25G 3/34

(52) U.S. Cl. CPC B25G 3/34
USPC 29/700

(57) ABSTRACT

A plastic insert for securing a knob to a gear lever has, firstly, a part secured onto a free end of the lever and, secondly, a space formed in the coaxial extension of the part. Limited coaxial movement of the knob and insert in relation to the lever occurs under the effect of a shock exerted on the knob, to dampen the shock.

The invention pertains to the technical sector of equipment items for motor vehicles, and particularly concerns a device for attaching a knob of a gear lever for controlling a gearbox.

Gear levers for engaging and selecting gears are always equipped with a knob on their free end, for operating the said lever. Different technical solutions have been proposed for attaching such a knob.

For example, the knob can be press-fitted onto a distortion provided on the end of the lever when it is machined, in combination with retaining ribs. The knob is press-fitted with relatively strong force, to obtain an effective fixation with good longevity. With this solution, it is difficult to see whether the knob has been adequately press-fitted.

It has also been proposed to screw the knob onto the end of the lever, which consequently requires producing a length of threading on the end of the lever, thereby augmenting production costs.

One advantageous solution is covered in patent FR 2725166, which describes a solution allowing one to secure the knob to the end of the lever by means of a clipping action. For this purpose, the securing device specified in this patent includes a plastic component added by molding it onto the end of the upper part of the lever. The said component has means of securing that allow the press-fitting of the knob and its subsequent dismounting.

However, it has been observed that, whatever technical solution is used for attaching the knob to the end of the lever, none of the said solutions are able to absorb—or at least dampen—the possible shocks exerted on the knob in the event of an accident, for example. Yet very many vehicles now have the gear lever positioned not on the vehicle's floor but on the dashboard, such that the knob is situated directly in the trajectory of the passenger or the driver, notably in the event of a frontal or rear impact. Consequently, there are risks of injury when the driver or the passenger hit the knob secured onto the lever, which constitutes a totally-rigid assembly.

The purpose of the invention is to remedy these disadvantages in a simple, sure, effective and rational manner.

The problem that the invention proposes to resolve is to be able to dampen the possible shocks that the knob might undergo.

To resolve such a problem, a device has been designed for securing a knob onto the lever of a gearbox for motor vehicles, having means able to allow limited coaxial movement of the knob in relation to the lever, under the effect of a shock exerted on the knob, in view of dampening the shock.

The invention finds a particularly advantageous application in the case of a device for securing a knob onto a gearbox control lever including a plastic insert molded onto one of the ends of the aforesaid lever, with the said insert being shaped to allow the securing of the knob, by means of a clipping effect, and its subsequent removal, such as comes to the fore in patent FR 2725166.

According to a basic characteristic of the invention, because of the problem to be resolved, the insert has workings that permit its limited coaxial movement in relation to the lever, under the effect of a shock exerted on the knob, in view of dampening the said shock.

The result of these arrangements is that, under the effect of a shock exerted on the knob, it can be moved to a greater or lesser distance dependent on the intensity of the shock, which has the concomitant effect of dampening such a shock.

To resolve the problem of enabling the displacement of the knob, the workings consist of a space formed in the extension of the part of the insert molded onto the end of the lever, coaxially to the aforementioned part, to allow the said movement.

The space can consist of a chambering or an open hole.

According to another characteristic, the insert is added by molding onto the end of the lever, in combination with securing means able to allow the coaxial movement of the said insert under the effect of the shock.

As comes to the fore in the reading of the above-stated French patent, the insert has external workings able to ensure the press-fitting of the knob with a weak introduction force and a strong withdrawal force. The lever has a round cross-section.

The invention is explained below in more detail, with the help of the appended Figures, in which:

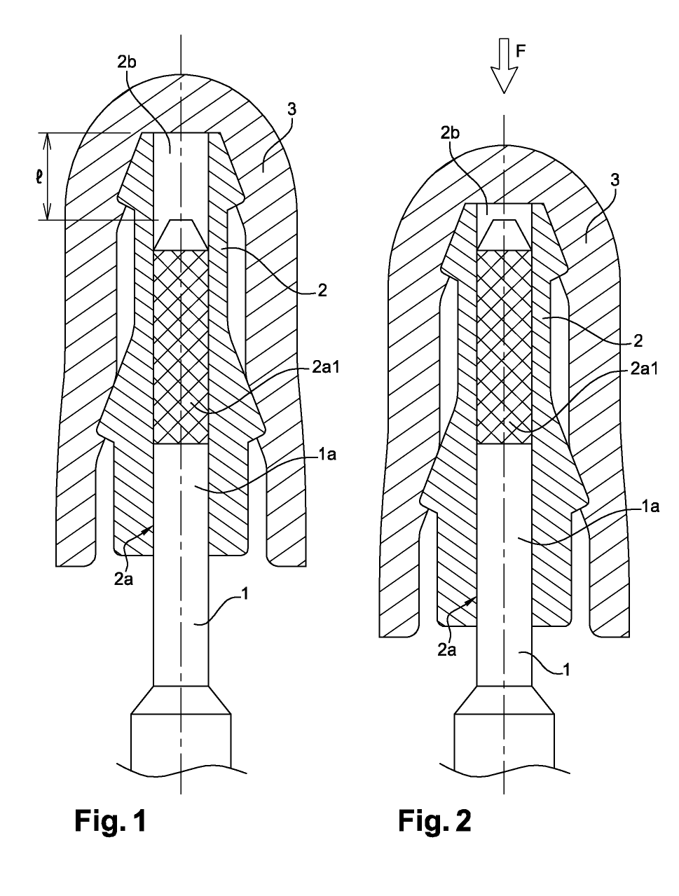

FIG. 1 is a longitudinal cross-section of the device for securing the knob in accordance with the invention, with the knob being illustrated in a so-called normal position of use;

FIG. 2 is a view corresponding to FIG. 1, showing the displacement of the entire knob in relation to the lever, under the effect of a shock exerted on the said knob.

The body of the lever (1), of any known and appropriate type, is—for example—of solid transversal cross-section, notably of round cross-section. The end (1a) of the lever is designed to accommodate a plastic insert (2) molded onto it, shaped to allow the press-fitting—under a clipping effect—of a knob (3), which can also be of any known and appropriate type.

For instance, the end (1a) of the said lever can have inset or salient protuberances, knurling or other means of allowing the molding of the insert (2) and its attachment.

The insert (2) has a hollow part (2a) molded onto the end (1a) of the lever (1). This hollow part (2a) is est extended by a space (2b) to allow limited coaxial movement of the insert (2) and, consequently, the entire knob (3) press-fitted onto the said insert, in relation to the lever (1). Such a displacement can result, for example, from a shock exerted on the knob (3). The movement of the insert (2)/knob (3) assembly has the effect of dampening the shock. This space (2b) can be constituted by a chambering or an open hole (figures of drawings).

It is obvious that the means of securing (2a1) the insert (2) in relation to the lever (1) after molding are designed to allow the coaxial movement of the said insert under the effect of a shock, symbolized by the arrow (F).

It comes to the fore from these characteristics, therefore, that after the molding of the insert (2) onto the end of the lever (1), the free end of the lever (1) is situated at a certain distance from the end of the insert (2), thereby forming a space (2b) of sufficient length (1) to allow limited movement of the knob (3)/insert (2) assembly in relation to the said lever (1). Under the effect of a shock (F) exerted on the end of the knob, the knob (3)/insert (2) assembly is displaced coaxially in relation to the lever (1), over all or part of the length (1) of the space (2b). This movement of the knob (3)/insert (2) assembly has the effect of dampening the shock (F).

The characteristics as such of the insert (2) and the workings designed to ensure the press-fitting of the knob with a weak introduction force and a strong withdrawal force are, for example, of the type described in the patent FR 2725166.

The advantages come clearly to the fore in the description; in particular, emphasis is placed on the clipping of the knob onto the lever, with a capability for limited movement of the said knob in relation to the lever, so as to dampen any shocks that the said knob might undergo.

1. Device for securing a knob of a lever of a gearbox for a motor vehicle, comprising a plastic insert for securing the knob to the lever, said insert having a hollow part with a first end secured onto a free ends of the lever, such that, after securing the first end of the insert onto the free end of the lever, said free end is situated at a certain distance from a second opposite end of the insert such that the said hollow part bounds a space of sufficient length to allow limited coaxial movement of the knob and the insert in relation to the lever, under effect of a shock exerted on the knob, to dampen the shock.

2. Device according to claim 1, wherein the space comprises a chamber.

3. Device according to claim 1, wherein the space comprises an open hole.

4. Device according to claim 1, in combination with means of securing the first end of the hollow part onto the free end of the lever such as to allow the coaxial movement of the said insert under the effect of the shock.

5. Device according to claim 1, wherein the insert has external workings ensuring press-fitting of the knob with a weak introduction force and a strong withdrawal force.

6. Device according to claim 1, wherein the lever is of round cross-section.
